(19) United States
(12) Patent Application Publication
(10) Pub. No.: US 2005/0126977 A1
(43) Pub. Date: Jun. 16, 2005

(54) Cleaning device for use with a floating member

(76) Inventor: Christopher W. Carter, Burlington (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 10/734,266

(22) Filed: Dec. 15, 2003

(51) Int. Cl. C02F 1/28

(52) U.S. Cl. 210/242.4

(57) ABSTRACT

A cleaning device for use with a floating member that is adapted to float substantially adjacent to, and to extend below, a fluid surface level in a recirculating fluid system that contains surface contaminants. The cleaning device includes an absorbent body member that has an active surface portion adapted to operatively absorb the surface contaminants from the fluid surface level. The cleaning device also has a securing system for removably securing the body member to the floating member.

### FIELD OF THE INVENTION

The present invention relates generally to the field of cleaning devices for use in recirculating fluid systems, and more particularly to a cleaning device for use with a floating member in a recirculating fluid system, such as, for example, a swimming or bathing system.

### BACKGROUND OF THE INVENTION

It is well known that, unless controlled, the fluid in swimming pools, spas, hot tubs and other recirculating swimming and bathing systems can become contaminated with algae and similarly undesirable organisms. In the past, such contaminant growth has been controlled by the addition of bromine, chlorine and/or other halogens to the water, and by the use of floating devices that dispense water-soluble solid sources of these materials. An example of such a floating spa brominator is disclosed in U.S. Pat. No. 4,630,634 (Sasaki et al.) for a Solid Chlorine Dispenser for Spas, the teachings of which patent are incorporated herein by reference. Hereinbelow, the term “chlorinator” is used interchangeably with the term “brominator”.

It is also known that recirculating fluid systems, including inter alia swimming and bathing systems, can become contaminated with contaminants that are oleophilic and/or hydrophobic (such as, for example, body oils). Various methods and devices have been developed to address this problem, including, among others, those disclosed in U.S. Pat. No. 4,894,166 (Pitts) for a Method for Cleaning Oil-Contaminated Water in a Swimming or Bathing Area, and in U.S. Pat. No. 5,676,839 (Shippert) for a Floatable Oil and Debris Collection Device. Freely movable skimming devices, inter alia as disclosed in the aforementioned patents, circulate on the surface of oil-contaminated bodies of water to absorb oil-based surface contaminants, and are comprised of at least one oil-absorbing material consisting of a hydrophobic cross-linked polyolefin foam. Materials known for their oil-absorbing qualities have previously been produced according to the method described in U.S. Pat. No. 4,435,346 (Ito et al.) for a Method of Producing Open-Cell Foamed Articles of Cross-Linked Polyolefins.

In the prior art, however, devices and methods for cleaning oleophilic and hydrophobic contaminants from the fluid surfaces of recirculating fluid systems have been subject to a further problem, especially insofar as previous free-floating absorbing devices have been susceptible to being drawn into the flow inlets, such as a skimmer, of such systems. This susceptibility typically causes concomitant inconvenience and costs to be incurred by the owners of such systems, since absorbing devices drawn into flow inlets tend to block and clog the water lines feeding the system's circulating pump, such as to require significant repair to the system and/or complete replacement of the pump motor.

It is, therefore, an object of the invention to provide a cleaning device for attachment to a floating member, such as, for example, a brominator or a chlorinator.

It is a further object of the invention to provide a cleaning device for attachment to a floating member for use in a recirculating fluid system, such as, for example, in a hot tub, in a swimming pool, or in another recirculating swimming or bathing system.

It is another object of the invention to provide a cleaning device for attachment to a floating member that is capable of absorbing surface contaminants, such as, for example, oleophilic and/or hydrophobic contaminants, that would otherwise accumulate substantially adjacent to a fluid surface level of the recirculating fluid system.

It is a further object of the invention to provide a cleaning device for attachment to a floating member that reduces the necessity of having two separately floating cleaning devices, namely, a surface contaminant cleaning device and a separately floating brominator or chlorinator, in the recirculating fluid system.

It is yet another object of the invention to provide a cleaning device for attachment to a floating member, so as to minimize the tendency of the cleaning device to be drawn into a flow inlet, such as, for example, a skimmer, of the fluid recirculating system.

It is yet a further object of the invention to provide a cleaning device for attachment to a floating member, so as to minimize the tendency of the cleaning device to block or clog a pump apparatus of the recirculating fluid system.

### SUMMARY OF THE INVENTION

There is thus provided, according to one aspect of the invention, a cleaning device for use with a floating member that is adapted to float substantially adjacent to, and to extend below, a fluid surface level in a recirculating fluid system that contains surface contaminants. The cleaning device comprises an absorbent body member having an active surface portion that is adapted to operatively absorb the surface contaminants from the fluid surface level. The cleaning device further comprises a securing means for removably securing the body member to the floating member.

According to another aspect of the invention, the securing means comprises a substantially central aperture formed at least partway through a bottom surface of the absorbent body member to provide an interior securing surface. The interior securing surface is adapted to removably secure the absorbent body member to the floating member as aforesaid. According to a further aspect of the invention, the substantially central aperture may be formed completely through the absorbent body member from the bottom surface.

According to yet another aspect of the invention, the absorbent body member comprises a porous absorbent material.

According to a still further aspect of the invention, the active surface portion comprises a furrowed surface portion that is adapted to absorb the surface contaminants. According to the invention, the furrowed surface portion may comprise one or more irregularly dimensioned furrow segments, or two or more regularly dimensioned furrow segments. According to a yet still further aspect of the invention, the absorbent body member has a substantially circular plan outline, with each of the furrow segments operatively extending upward from the fluid surface level, and extending radially inward along a top surface of the absorbent body member.

According to another aspect of the invention, the interior securing surface is shaped and dimensioned to removably secure the absorbent body member to the floating member by frictional means.

According to a yet further aspect of the invention, when the absorbent body member is secured to the floating member as aforesaid, the absorbent body member is adapted to resist being drawn into a flow inlet of the recirculating fluid system.

According to another aspect of the invention, there is provided a cleaning device in combination with a floating member for dispensing a disinfectant agent into a recirculating fluid system. The recirculating fluid system defines a fluid surface level and contains surface contaminants. The floating member has an upper portion adapted to float substantially adjacent to the fluid surface level. The floating member also has a lower portion that engages the upper portion and extends below the fluid surface level. The cleaning device comprises an absorbent body member that has an active surface portion adapted to operatively absorb the surface contaminants from the fluid surface level. The active surface portion comprises a furrowed surface portion that is adapted to absorb the surface contaminants. The absorbent body member comprises a porous absorbent material. The cleaning device further comprises a securing means for removably securing the body member to the floating member. The securing means comprises a substantially central aperture that is formed at least partway through a bottom surface of the absorbent body member to provide an interior securing surface. The interior securing surface is adapted to removably secure the absorbent body member to the floating member as aforesaid. According to this aspect of the invention, when the absorbent body member is secured to the floating member as aforesaid, the combination is adapted to resist being drawn into a flow inlet of the recirculating fluid system.

According to another aspect of the invention, the disinfectant agent designed to be dispensed by the floating member comprises a water-soluble halogen.

### BRIEF DESCRIPTION OF THE DRAWINGS

The novel features which are believed to be characteristic of the present invention, as to its structure, characteristics, features, organization, use and method of operation, together with further objectives and advantages thereof, will be better understood from the appended claims and the remainder of the specification hereinbelow, along with the following drawings in which a presently preferred embodiment of the invention is illustrated by way of example. It is expressly understood, however, that the drawings are for the purpose of illustration and description only, and are not intended as a definition of the limits of the invention. In the accompanying drawings:

FIG. 1 is a top side perspective view of a preferred embodiment of a cleaning device according to the present invention, shown in use in a recirculating fluid system;

FIG. 2 is a side elevational view of the cleaning device of FIG. 1, shown with a chlorinator in a mounted configuration;

FIG. 3 is a top side perspective view of the cleaning device of FIG. 2, shown with the chlorinator in a disengaged configuration;

FIG. 4 is a top side perspective view of the cleaning device of FIG. 2;

FIG. 5 is a partially sectional view of the preferred embodiment of the cleaning device along sight line 5-5 of FIG. 4.

FIG. 6 is a top side perspective view of an alternate embodiment of a cleaning device according to the present invention, shown with the chlorinator in the disengaged configuration;

FIG. 6B is a top side perspective view of the cleaning device of FIG. 6, shown with the chlorinator in the mounted configuration; and

FIG. 7 is a partially sectional view of the alternate embodiment of the cleaning device along sight line 7-7 of FIG. 6B.

### DETAILED DESCRIPTION OF A PREFERRED EMBODIMENT

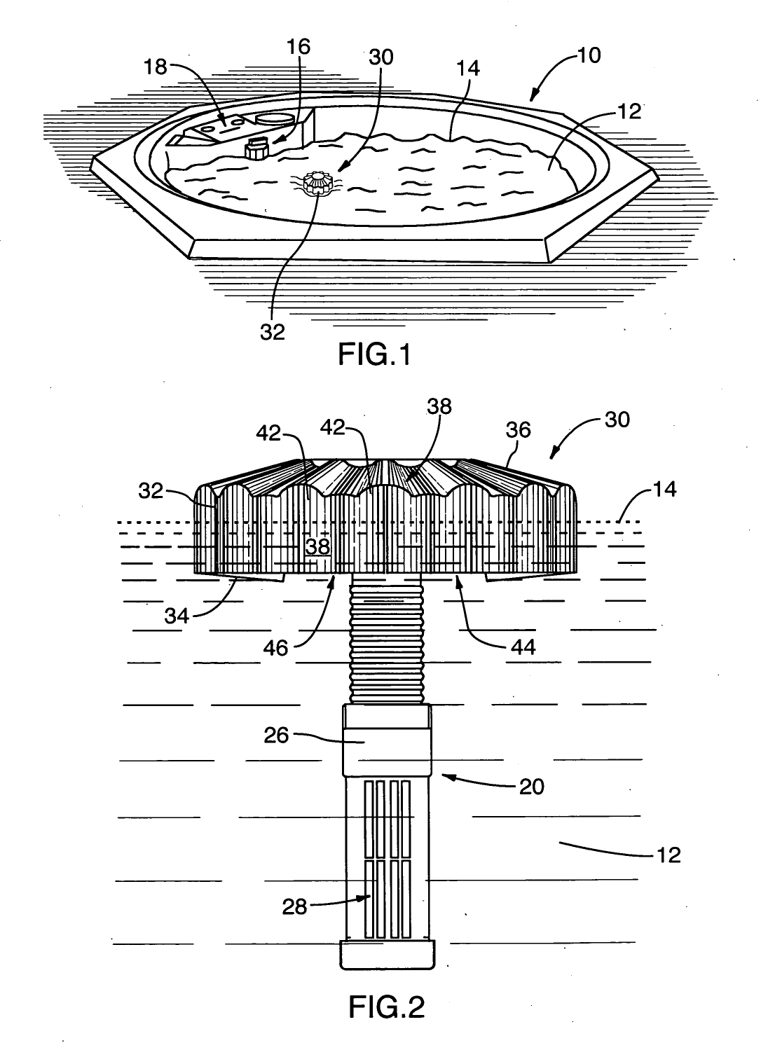

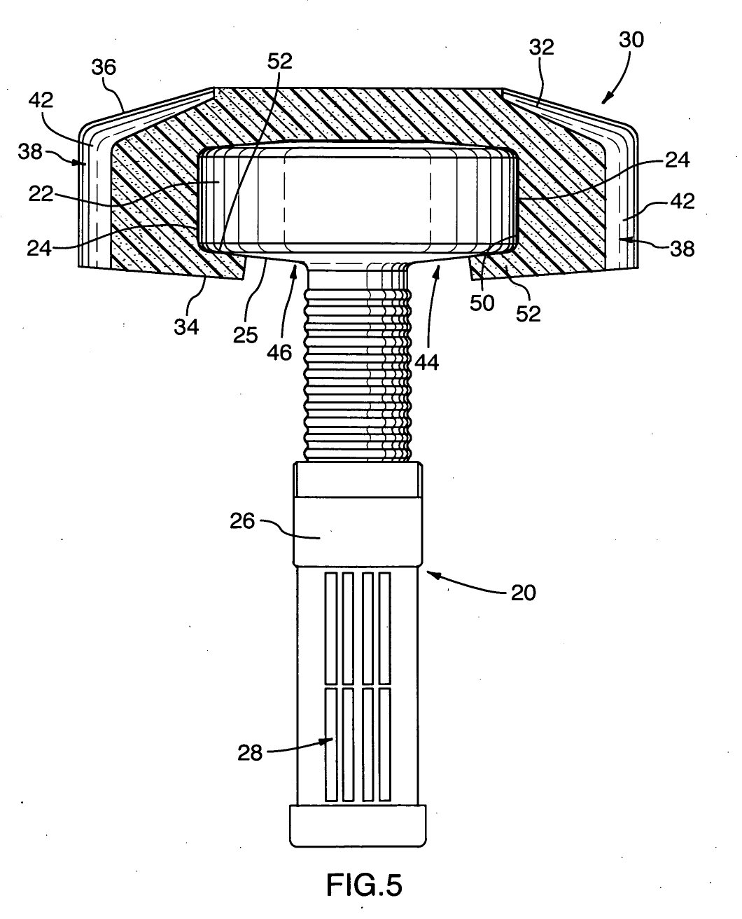

FIGS. 1 through 7 of the drawings depict a cleaning device 30 for use with a floating member 20 according to the invention. With specific reference to FIG. 1 of the drawings, the cleaning device 30 is illustrated as used in a recirculating fluid system 10 that contains a fluid 12 and surface contaminants (not shown) substantially adjacent to a fluid surface level 14 thereof. The recirculating fluid system 10 shown in FIG. 1 is of the general type having a pump apparatus 18 and a skimmer or flow inlet 16. The recirculating fluid system 10 may, for example, be a hot tub (as depicted in FIG. 1), a swimming pool, or any other type of recirculating swimming or bathing system.

In a preferred embodiment of the invention, shown in FIGS. 1 through 5, the cleaning device 30 includes an absorbent body member 32 that has an active surface portion—in particular, a furrowed surface portion 38—that is adapted to operatively absorb the surface contaminants (not shown) from the fluid surface level 14 when the cleaning device 30 is used in the recirculating fluid system 10 as aforesaid. The furrowed surface portion 38 is comprised of a plurality of regularly dimensioned furrow segments 42, so as to effectively maximize the ability of the active surface portion to absorb surface contaminants by increasing its surface area that is in substantially adjacent operative contact with the fluid surface level 14. It should be noted that, in place of or in addition to the regularly dimensioned furrow segments 42, the furrowed surface portion 38 of the cleaning device 30 may alternately be provided with one or more irregularly dimensioned furrow segments (not shown) in the form of any of a variety of geometric and other shapes that likewise maximize the surface area of the active surface portion. As best appreciated from FIGS. 1, 3 and 4, the absorbent body member 32 has a substantially circular plan outline, with each of the furrow segments 42 operatively extending upward from the fluid surface level 14, and extending radially inward along a top surface 36 of the absorbent body member 32.

The absorbent body member 32 is preferably constructed from a porous absorbent material that is selected from a group consisting of natural sponges, open-cell oil-absorbing foam, compressible open-cell polyolefin foam, polyethylene foam, closed-cell foam, and combination open and closed cell foam. Alternately, any other suitably absorbent or adhesive material, porous or non-porous, might be used in the construction the active surface portion of the absorbent body member 32.

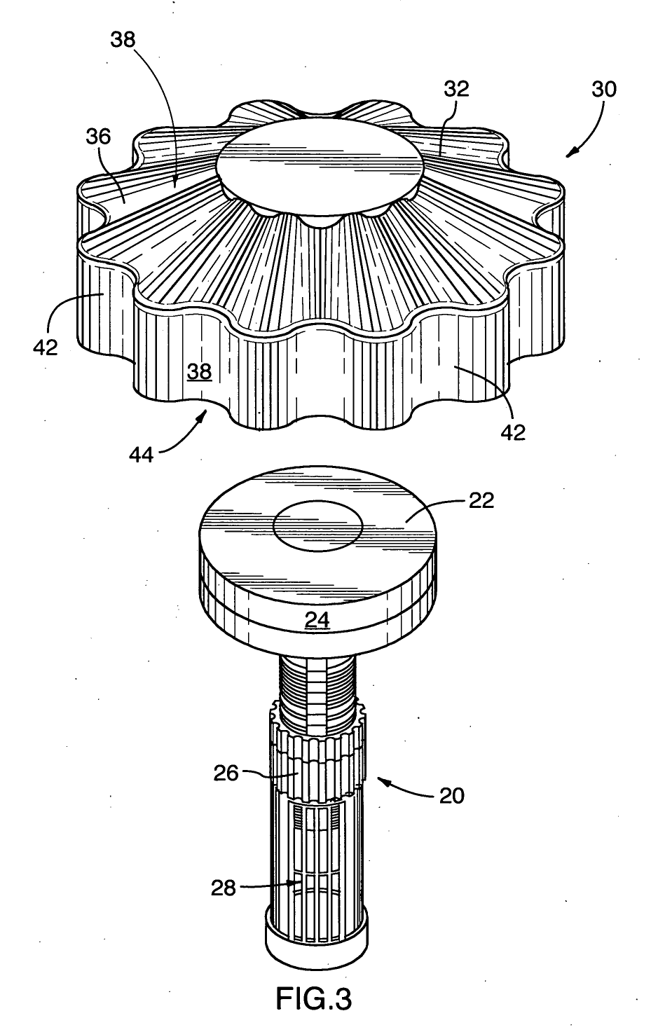

The cleaning device 30 also includes a securing means 44 for removably securing the absorbent body member 32 to a floating member 20 in a mounted configuration (as shown in FIGS. 2, 4 and 5). The floating member 20 depicted in FIGS. 2 through 7 is identical to the chlorinator disclosed in U.S. Pat. No. 4,630,634 (Sasaki et al.), discussed above, and it has a buoyant upper portion 22 that is adapted to float substantially adjacent to the fluid surface level 14. A ballasting lower portion 26 of the floating member 20 engages an underside surface 25 of the upper portion 22 and, as best shown in FIG. 2, extends downwardly therefrom below the fluid surface level 14. The lower portion 26 of the floating member 20 is shaped so as to define disinfectant dispensing apertures 28 therethrough for dispensing a disinfectant agent (not shown) when used in the recirculating fluid system 10. Preferably, the disinfectant agent dispensed by the floating member 20 is a water-soluble halogen, such as, inter alia, chlorine or bromine. Although the floating member 20 is depicted in the figures as being identical to the chlorinator disclosed in the aforementioned Sasaki patent, it is worthwhile to note that the floating member 20 may alternately take the form of any other commercially available brominator, chlorinator, or, indeed, any other structure or device that has suitable floating characteristics (including those devices that are not, in and of themselves, capable of dispensing disinfectant agents).

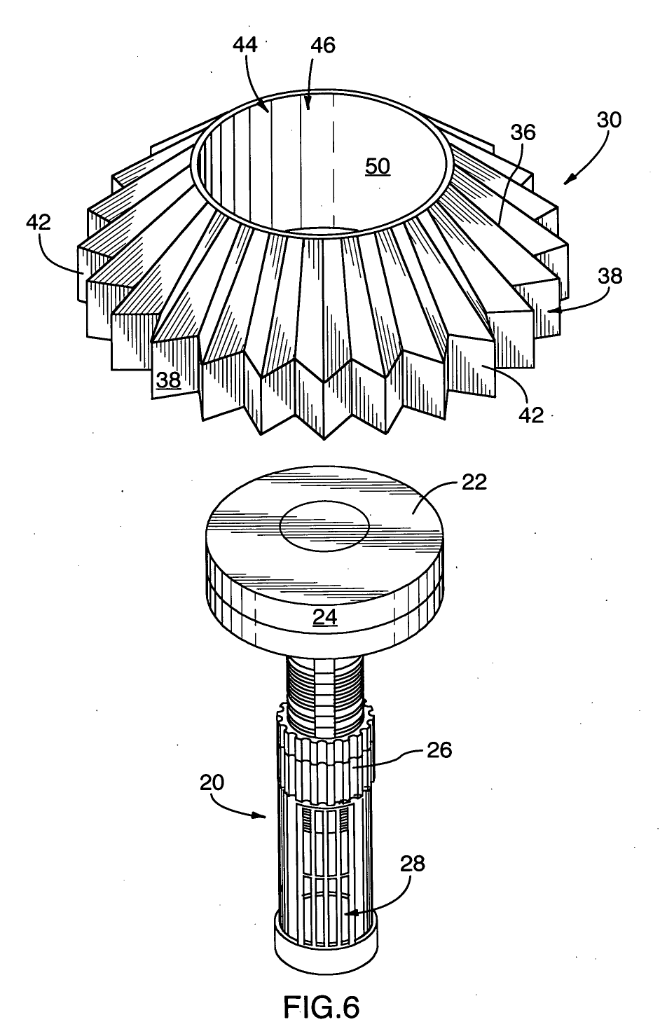

As best seen in FIG. 5, the securing means 44 of the cleaning device 30 comprises a substantially central aperture 46 that is formed partway through a bottom surface 34 of the absorbent body member 32 to provide an interior securing surface that is adapted to removably secure the absorbent body member 32 to the buoyant upper portion 22 of the floating member 20. The interior securing surface takes the form of an inner frictional surface 50, namely, a side surface, that is shaped and dimensioned to removably secure the absorbent body member 32 to an outer edge surface 24 of the upper portion 22 of the floating member 20 by frictional means. In the preferred embodiment shown in FIGS. 1 through 5 (and as best seen in FIG. 5), the interior securing surface also includes a flexible obstructing lip member 52 extending from the bottom surface 34 of the absorbent body member 32 substantially adjacent to the central aperture 46, with the obstructing lip member 52 being adapted to engage the underside surface 25 of the upper portion 22 of the floating member 20 in the mounted configuration.

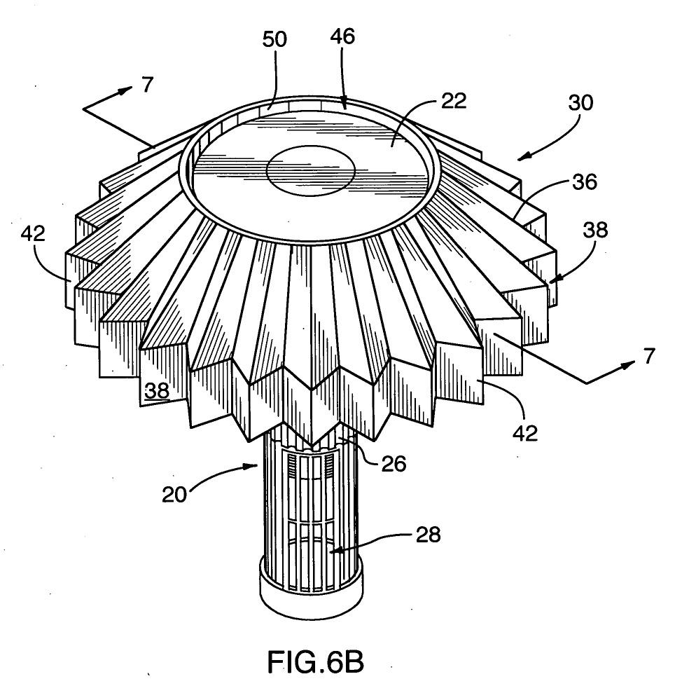

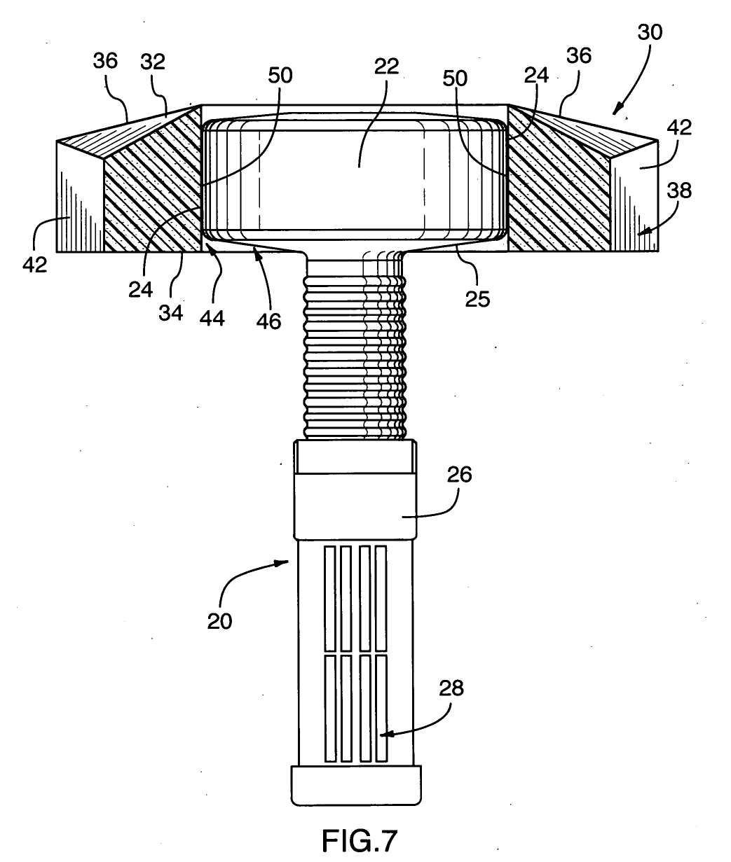

FIGS. 6 through 7 illustrate an alternate embodiment of the cleaning device 30′ according to the present invention, in which figures, the same reference numerals have been used to indicate objects, surfaces, and components which are common to both the preferred embodiment and the alternate embodiment. The alternate embodiment of the cleaning device 30′ differs from the preferred embodiment insofar as the substantially central aperture 46 is formed completely through the absorbent body member 32 from the bottom surface 34 to the top surface 36. The alternate embodiment of the cleaning device 30′ is shown in the disengaged configuration in FIG. 6, and in the mounted configuration in FIGS. 6B and 7. In the alternate embodiment, and as best seen in FIG. 7, the interior securing surface of the securing means 44 does not include an obstructing lip member 52, but instead only takes the form of the inner frictional surface 50, namely, the side surface, that is shaped and dimensioned to removably secure the absorbent body member 32 to the outer edge surface 24 of the upper portion 22 of the floating member 20 by frictional means.

In use, when either of the preferred and alternate embodiments of the cleaning device, 30 and 30′ respectively, is removably secured to the floating member 20 in the mounted configuration in the manner as aforesaid (and as shown in FIGS. 2, 4, 5, 6B and 7), the combined floating member 20 and cleaning device, 30 or 30′, may be positioned in the recirculating fluid system 10, with the furrowed surface portion 38 positioned substantially adjacent to, and in operative absorbing contact with, the fluid surface level 14 (as best shown in FIG. 2) so as to absorb surface contaminants (not shown) therefrom. Both the preferred and the alternate embodiments of the cleaning device, 30 and 30′ respectively, are capable of absorbing surface contaminants (not shown) from the fluid surface level 14, such surface contaminants including, inter alia, oleophilic contaminants and hydrophobic contaminants, as well as contaminants that are both oleophilic and hydrophobic.

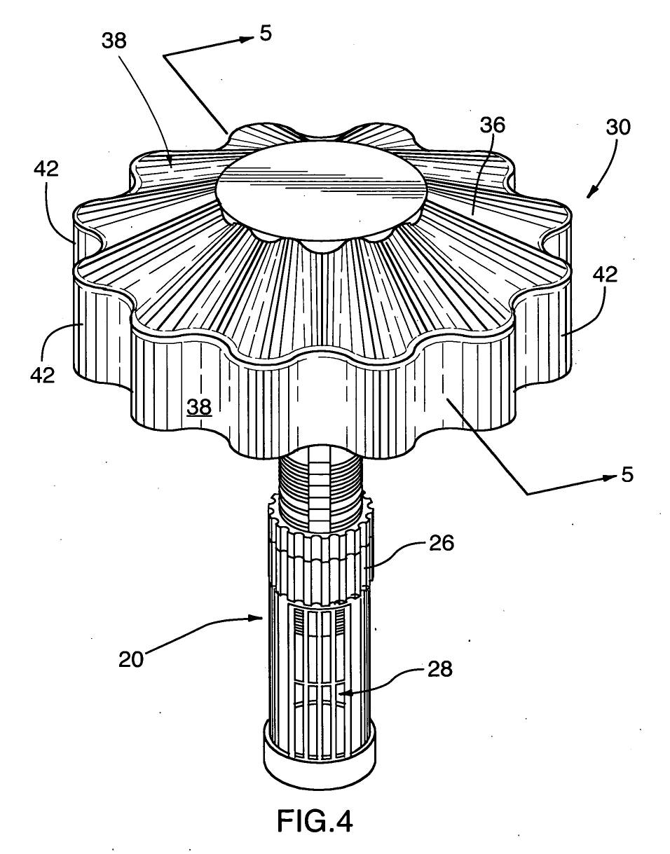

On saturation of the furrowed surface portion 38 with surface contaminants (not shown), the cleaning device 30 may be removed from the recirculating fluid system 10, the obstructing lip member 52 may be folded back, and the absorbent body member 32 of the cleaning device 30 may be removed from the floating member 20 to reach a disengaged configuration (shown in FIG. 3), in which the absorbent body member 32 may be easily cleaned. Whether in the disengaged configuration or otherwise, the cleaning device 30 may be cleaned of surface contaminants by washing same with clean water, by squeezing the absorbent body member 32 to remove any contaminants that may be trapped therewithin, or by any other suitable means. Thereafter, the cleaning device 30 may be reused in the recirculating fluid system.

When either of the preferred and alternate embodiments of the cleaning device, 30 and 30′ respectively, is removably secured to the floating member 20, with its downwardly extending lower portion 26, they are together adapted to resist-being drawn into the flow inlet 16 of the recirculating fluid system 10. As such, the combined cleaning device, 30 or 30′, and floating member 20 have a reduced tendency to cause concomitant inconvenience and costs to be incurred by the owners of such systems, and a similarly reduced tendency to block and clog the pump apparatus 18 or any water lines of the recirculating fluid system 10.

Because the cleaning device, 30 and/or 30′, is capable of absorbing surface contaminants, and because it is designed to be secured to the floating member 20 that is of the general type that is capable of dispensing chlorine or bromine, the present invention reduces any necessity of having two separately floating cleaning devices in the recirculating fluid system 10.

Other modifications and alterations may be used in design and manufacture according to the present invention without departing from the spirit and scope of the invention, which is limited only by the accompanying claims. For example, the shape of the cleaning device 30, 30′ is shown to be substantially planar, though it may be modified to be of various geometric shapes. The active surface portion is specified as being provided in the form of the furrowed surface portion 38, but instead, it might take the form of a vacuum filtering device for absorbing surface contaminants from the fluid surface level 14. In another modification that lies within the scope of the invention, the cleaning device 30 may be securely, or removably, attached to the floating member 20 by means other than by way of frictional engagement, such as, for example, by way of a tether or by gravity-biasing. Further, although the present invention is depicted in use in a recirculating fluid system 10 of the general type used for swimming or bathing, it might instead be adapted for use in an industrial or chemical fluid system, and/or in a recirculating gaseous fluid system. Obviously, the present invention allows for a wide variety of different possible combinations of the various modifications and alterations specifically contemplated herein, and as such, it should perhaps be noted once again that the present invention is limited only by the accompanying claims.

1. A cleaning device for use with a floating member that extends below a fluid surface level in a recirculating fluid system containing surface contaminants, said cleaning device comprising:
an absorbent body member having an active surface portion adapted to operatively absorb said surface contaminants from said fluid surface level; and
a securing means for removably securing said absorbent body member to said floating member with said active surface portion in contactable relation to said fluid surface level, said securing means comprising a substantially central aperture formed at least partway through a bottom surface of said absorbent body member to provide a substantially continuous interior securing surface, with said substantially continuous interior securing surface being adapted to removably secure said absorbent body member to said floating member in substantially fixed relation thereto.

2. (canceled)

3. A cleaning device according to claim 1, wherein said absorbent body member comprises a porous absorbent material.

4. A cleaning device according to claim 3, wherein said active surface portion comprises a furrowed surface portion adapted to absorb said surface contaminants.

5. A cleaning device according to claim 4, wherein said furrowed surface portion comprises two or more regularly dimensioned furrow segments.

6. A cleaning device according to claim 5, wherein said absorbent body member has a substantially circular plan outline, with each of said furrow segments operatively extending upward from said fluid surface level, and extending radially inward along a top surface of said absorbent body member.

7. A cleaning device according to claim 6, wherein said interior securing surface is shaped and dimensioned to removably secure said absorbent body member to said floating member by frictional means.

8. A cleaning device according to claim 7, wherein said absorbent body member is adapted to be cleaned and reused.

9. A cleaning device according to claim 8, wherein, when said absorbent body member is secured to said floating member, said absorbent body member is adapted to resist being drawn into a flow inlet of said recirculating fluid system.

10. A cleaning device according to claim 9, wherein said substantially central aperture is formed completely through said absorbent body member from said bottom surface.

11. A cleaning device according to one of claims 9 and 10, wherein said porous absorbent material is selected from the group consisting of natural sponges, open-cell oil-absorbing foam, compressible open-cell polyolefin foam, polyethlene foam, closed-cell foam, and combination open and closed cell foam.

12. A cleaning device in combination with a floating member for dispensing a disinfectant agent into a recirculating fluid system, said recirculating fluid system defining a fluid surface level and containing surface contaminants, said combination comprising:
(a) said floating member having an upper portion adapted to float substantially adjacent to said fluid surface level, and a lower portion engaging said upper portion and extending below said fluid surface level, said floating member also having a means for dispensing said disinfectant agent into said recirculating fluid system;
(b) said cleaning device comprising:
(i) an absorbent body member having an active surface portion adapted to operatively absorb said surface contaminants from said fluid surface level, with said active surface portion comprising a furrowed surface portion adapted to absorb said surface contaminants, and with said absorbent body member comprising a porous absorbent material; and
(ii) a securing means for removably securing said body member to said floating member, said securing means comprising a substantially central aperture formed at least partway through a bottom surface of said absorbent body member to provide an interior securing surface, said interior securing surface adapted to removably secure said absorbent body member to said floating member; and
such that when said absorbent body member is secured to said floating member, said combination is adapted to resist being drawn into a flow inlet of said recirculating, fluid system.

13. A combination according to claim 12, wherein said disinfectant agent comprises a water-soluble halogen.

14. A combination according to claim 13, wherein said furrowed surface portion comprises two or more regularly dimensioned furrow segments.

15. A combination according to claim 14, wherein said absorbent body member has a substantially circular plan outline, with each of said furrow segments operatively extending upward from said fluid surface level, and extending radially inward from said substantially circular plan outline along a top surface of said absorbent body member.

16. A cleaning device according to claim 15, wherein said interior securing surface is shaped and dimensioned to removably secure said absorbent body member to said floating member by frictional means.

17. A cleaning device according to claim 16, wherein said absorbent body member is adapted to be cleaned and reused.

18. A cleaning device according to claim 17, wherein said substantially central aperture is formed completely through said absorbent body member from said bottom surface.
